(19) United States
(12) Patent Application Publication
(10) Pub. No.: US 2013/0127274 A1
(43) Pub. Date: May 23, 2013

(54) SPINDLE MOTOR

(71) Applicants: Ta Kyoung Lee, Hwaseong (KR); Il Oung Park, Seoul (KR)

(72) Inventors: Ta Kyoung Lee, Hwaseong (KR); Il Oung Park, Seoul (KR)

(73) Assignee: SAMSUNG ELECTRO-MECHANICS CO., LTD., Suwon (KR)

(21) Appl. No.: 13/359,616

(22) Filed: Jan. 27, 2012

(30) Foreign Application Priority Data
Nov. 17, 2011 (KR) 10-2011-0120232

(51) Int. Cl. H02K 1/27; H02K 7/08

(52) U.S. Cl. 310/90; 310/156.07

(57) ABSTRACT

There is provided a spindle motor including: a hub operating together with a shaft and including a magnet; a base coupled to a sleeve supporting the shaft and including a core having a coil wound therearound, the coil generating rotational driving force; and a shielding part provided on the magnet and blocking magnetic flux introduced from the magnet into the base to thereby increase magnetic flux density between the magnet and the core, wherein the shaft and the hub rotate while descending via oil when power is applied to the coil.

### CROSS-REFERENCE TO RELATED APPLICATIONS

This application claims the priority of Korean Patent Application No. 10-2011-0120232 filed on Nov. 17, 2011, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor capable of being used in a hard disk drive capable of rotating a recording disk.

2. Description of the Related Art

A hard disk drive (HDD), a computer information storage device, reads data stored on a disk or writes data to the disk using a magnetic head.

In a hard disk drive, a base has a head driver installed thereon, that is, a head stack assembly (HSA), capable of altering a position of the magnetic head relative to the disk. The magnetic head performs its function while moving to a desired position in a state in which it is suspended above a writing surface of the disk by the head driver at a predetermined height.

According to the related art, in manufacturing a base provided in the hard disk drive, a post-processing scheme of die-casting aluminum (Al) and then removing burrs, or the like, generated due to the die-casting has been used.

However, in a die-casting process according to the related art, since a process of injecting molten aluminum (Al) for forging into a mold to form a shape for a component is performed, high temperatures and pressure are required, such that a large amount of energy is required in the process and a process time is increased.

Further, even in terms of a lifespan of a die-casting mold, there is a limitation in manufacturing a large number of bases using a single mold, and a base manufactured by the die-casting process has defects in dimensional precision.

Therefore, a base has been manufactured by press-processing a plate-shaped steel in order to solve the defects of the die-casting process. However, due to the characteristics of the steel, the base manufactured by press processing may be magnetic.

Due to the characteristics of the base described above, electromagnetic attraction force acts between the base and a magnet provided to a hub. This electromagnetic attraction force hinders the implementation of a stable rotation height of a rotating member.

In addition, due to the base being magnetic, magnetic flux of the magnet may be leaked along the base, such that efficiency of the spindle motor is reduced.

Therefore, research into a technology for significantly increasing the performance and lifespan of a spindle motor by blocking magnetic flux leaked from a magnet, simultaneously with implementing a stable rotation height of a rotating member in a base manufactured by press-processing a plate-shaped steel, is urgently required.

### SUMMARY OF THE INVENTION

An aspect of the present invention provides a spindle motor having a new shaft system structure to implement a stable rotation height of a rotating member, simultaneously with improving rotational characteristics, by significantly reducing magnetic flux leaked from a magnet.

According to an aspect of the present invention, there is provided a spindle motor including: a hub operating together with a shaft and including a magnet; a base coupled to a sleeve supporting the shaft and including a core having a coil wound therearound, the coil generating rotational driving force; and a shielding part provided on the magnet and blocking magnetic flux introduced from the magnet into the base to thereby increase magnetic flux density between the magnet and the core, wherein the shaft and the hub rotate while descending via oil when power is applied to the coil.

The shielding part may be provided on a lower surface of the magnet.

The shielding part may be magnetic.

The shielding part may be extended outwardly of the magnet to thereby be coupled to the hub.

The hub may include a receiving part receiving an outer side of the shielding part therein, and the shielding part may be received in the receiving part to thereby be coupled to the hub.

The shielding part may include an extension part formed by bending an outer side thereof upwardly in an axial direction, and the extension part may be received in the receiving part to thereby be coupled to the hub.

The shielding part may be extended to an outer peripheral surface of the hub to thereby enclose the outer peripheral surface of the hub.

The shielding part may be extended from a lower surface of the magnet to an inner peripheral surface of the magnet to thereby be coupled to the inner peripheral surface of the magnet.

The shielding part may have at least one protrusion part formed on a surface thereof corresponding to a lower surface of the magnet, the protrusion part contacting the magnet to thereby be coupled to the magnet.

The base may be magnetic.

The spindle motor may further include a thrust plate coupled to a lower portion of the shaft, wherein force allowing the shaft and the hub to descend is generated by thrust dynamic pressure via the oil by a thrust dynamic pressure part formed in at least one of an upper surface of the thrust plate and the sleeve facing the upper surface of the thrust plate.

The thrust plate and the sleeve may be maintained in a state in which they contact each other when the spindle motor is stopped.

The shaft and the thrust plate may be formed integrally with each other.

A magnetic center of the magnet may be disposed at a position lower than that of a center of the core in an axial direction.

The oil may be sealed by an interface of the oil formed between an upper surface of the sleeve and a lower surface of the hub facing the upper surface of the sleeve.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is a schematic cross-sectional view showing a state in which the spindle motor according to the embodiment of the present invention is stopped;

FIG. 3 is a schematic cut-away perspective view showing a sleeve provided in the spindle motor according to the embodiment of the present invention;

FIG. 4 is a schematic enlarged cross-sectional view showing a first modified example of part A of FIG. 1;

FIG. 5 is a schematic enlarged cross-sectional view showing a second modified example of part A of FIG. 1;

FIG. 6 is a schematic enlarged cross-sectional view showing a third modified example of part A of FIG. 1;

FIG. 7 is a schematic enlarged cross-sectional view showing a fourth modified example of part A of FIG. 1;

FIG. 8 is a schematic enlarged cross-sectional view showing a fifth modified example of part A of FIG. 1;

FIG. 9 is a schematic enlarged cross-sectional view showing a sixth modified example of part A of FIG. 1; and

FIG. 10 is a schematic enlarged cross-sectional view showing a seventh modified example of part A of FIG. 1.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

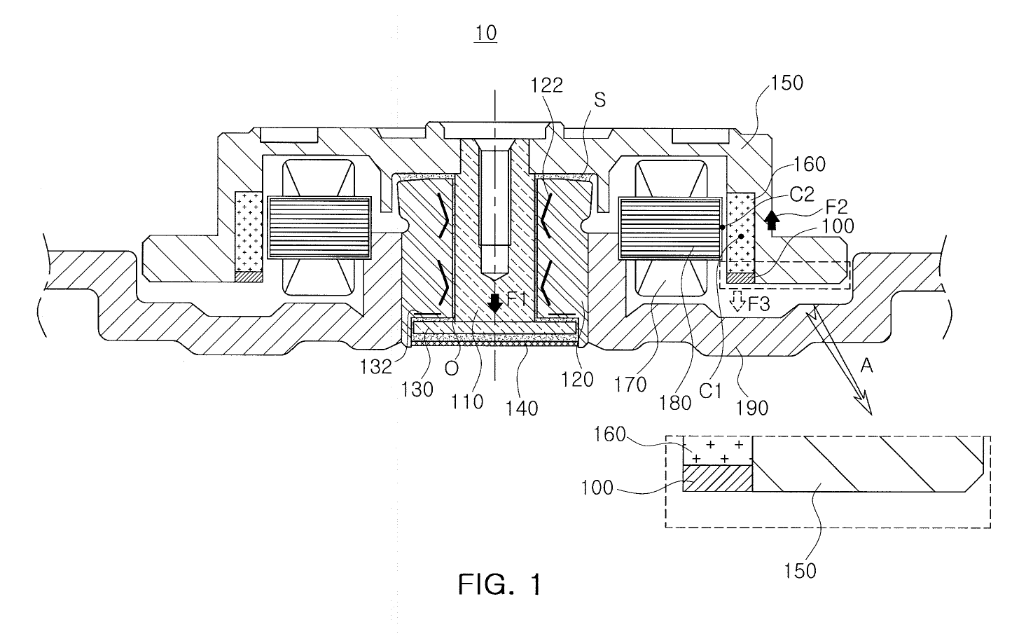

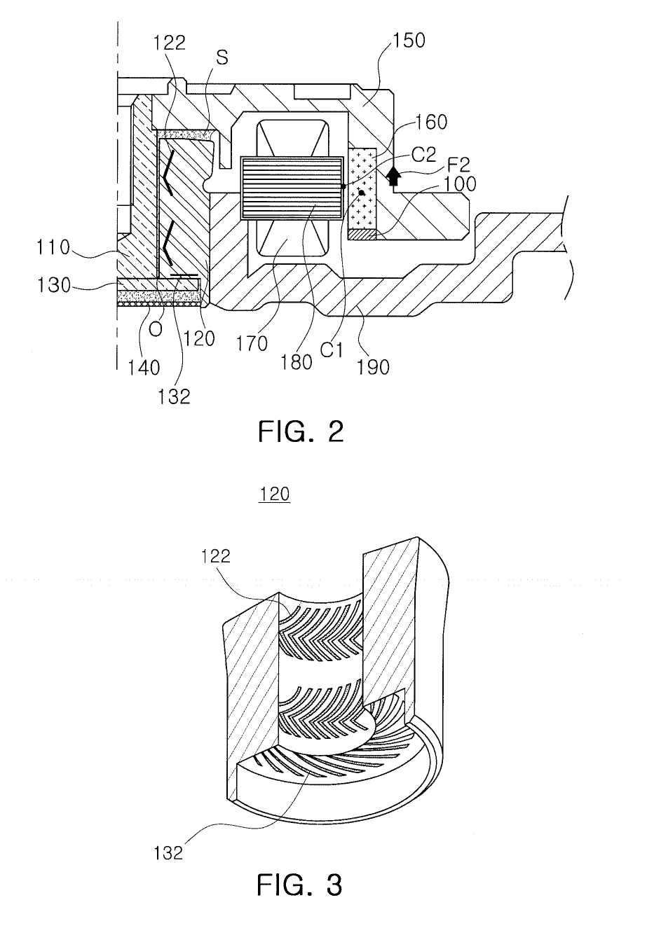

FIG. 1 is a schematic cross-sectional view showing a spindle motor according to an embodiment of the present invention; FIG. 2 is a schematic cross-sectional view showing a state in which the spindle motor according to the embodiment of the present invention is stopped; and FIG. 3 is a schematic cut-away perspective view showing a sleeve provided in the spindle motor according to the embodiment of the present invention.

Terms with respect to directions will be first defined. As viewed in FIG. 1, an axial direction refers to a vertical direction based on a shaft 110, and an outer diameter or inner diameter direction refers to a direction towards an outer edge of a hub 150 based on the shaft 110 or a direction towards the center of the shaft 110 based on the outer edge of the hub 150.

In addition, a circumferential direction refers to a rotation direction of the shaft 110, that is, a direction corresponding to an outer peripheral surface of the shaft 110.

Referring to FIGS. 1 through 3, a spindle motor 10 according to the embodiment of the present invention may include the hub 150, a component of a rotating member, and a base 190 and a shielding part 100, components of a fixed member. Here, the rotating member may rotate while descending.

The shaft 110, a component of the rotating member coupled to hub 150 to thereby rotate together with the hub 150, may be supported by a sleeve 120.

Meanwhile, the hub 150, a rotating structure provided to be rotatable with respect to the fixed member including the base 190, may include an annular ring-shaped magnet 160 provided on an inner peripheral surface thereof, and the annular ring-shaped magnet 160 corresponds to a core 180, while having a predetermined interval therebetween, the core 180 having a coil 170 wound therearound.

Here, the magnet 160 may electromagnetically interact with the coil 170 wound around the core 180 to thereby generate rotational driving force of the spindle motor 10 according to the embodiment of the present invention.

The sleeve 120, a component supporting the shaft 110, may support the shaft 110 such that an upper end of the shaft 110 protrudes upwardly in the axial direction and may be formed by forging Cu or Al or sintering a Cu—Fe based alloy powder or a steel use stainless (SUS) based power.

In addition, the sleeve 120 may include a shaft hole having the shaft 110 inserted thereinto such that the sleeve 120 and the shaft 110 have a micro clearance therebetween, and the micro clearance may be filled with a lubricating fluid O to thereby stably support the shaft 110 by radial dynamic pressure via the lubricating fluid O.

Here, the radial dynamic pressure via the oil O may be generated by a fluid dynamic pressure part 122 formed as a groove in an inner peripheral surface of the sleeve 120. The fluid dynamic pressure part 122 may have one of a herringbone shape, a spiral shape, a screw shape.

However, the fluid dynamic pressure part 122 is not limited to being formed in the inner peripheral surface of the sleeve 120 as described above but may also be formed in an outer peripheral surface of the shaft 110, which is a component of the rotating member. In addition, the number of fluid dynamic pressure parts 122 is also not limited.

In addition, the sleeve 120 may include a thrust dynamic pressure part 132 formed in a lower surface thereof, and the thrust dynamic pressure part 132 pumps the oil O filled in a clearance between the sleeve 120 and a thrust plate 130 to be described below in the inner diameter direction to thereby generate force F1 directed downwardly in the axial direction on the thrust plate 130, which is a component of the rotating member.

The thrust dynamic pressure part 132 may generate thrust dynamic pressure via the oil O at the time of rotation of the shaft 110, and the thrust dynamic pressure may generate the force F1 directed downwardly in the axial direction on an upper surface of the thrust plate 130.

Here, the thrust dynamic pressure part 132 may have one of a herringbone shape, a spiral shape, a screw shape, similar to the fluid dynamic pressure part 122.

However, the thrust dynamic pressure part 132 is not limited to being formed in the lower surface of the sleeve 120 but may also be formed in the upper surface of the thrust plate 130, which is a component of the rotating member.

Here, the sleeve 120 may include a base cover 140 coupled thereto at a lower portion thereof in the axial direction, while having a clearance maintained therebetween, the clearance receiving the oil O therein.

The base cover 140 may receive the oil O in the clearance between the base cover 140 and the sleeve 120 to thereby serve as a bearing supporting a lower surface of the shaft 110.

In addition, the oil O may be continuously filled in the clearance between the shaft 110 and the sleeve 120, in a clearance between the hub 150 to be described below and the sleeve 120, and in a clearance between the base cover 140 and the shaft 110 and the thrust plate 130 to be described below to thereby entirely form a full-fill structure.

Further, an interval between an upper surface of the sleeve 120 and the hub 150 facing the upper surface of the sleeve 120 may increase in the outer diameter direction.

More specifically, as shown in FIG. 1, the upper surface of the sleeve 120 may be inclined downwardly in the outer diameter direction.

In addition, although not shown, one surface of the hub 150 facing the upper surface of the sleeve 120 may be inclined upwardly in the outer diameter direction or the upper surface of the sleeve 120 and one surface of the hub 150 may be simultaneously inclined.

This is to prevent leakage of the oil O by using a capillary phenomenon of the oil O filled in the clearance between the upper surface of the sleeve 120 and the hub 150 facing the upper surface of the sleeve 120 to thereby significantly increase sealing capability of the oil O simultaneously with securing a storage space of the oil O.

An interface of the oil O may be formed between the upper surface of the sleeve 120 and one surface of the hub 150 facing the supper surface of the sleeve. In addition, an oil sealing part S maintaining the interface of the oil O in a normal state may be provided between the upper surface of the sleeve 120 and one surface of the hub 150.

Here, the oil sealing part S may be formed by the upper surface of the sleeve 120 and a lower surface of the hub 150. More specifically, the oil sealing part S means an interval between the upper surface of the sleeve 120 and the lower surface of the hub 150.

Therefore, in the spindle motor 10 according to the embodiment of the present invention, the interface of the oil O is formed between the upper surface of the sleeve 120 and the lower surface of the hub 150 to improve horizontal sealing of the oil O, whereby scattering of the oil O due to external impacts, or the like, may be prevented.

The base 190, which is a component coupled to the sleeve 120 to thereby support the rotation of the rotating member, may include the core 180 coupled thereto, the core 180 having the coil 170 wound therearound.

In other words, the base 190, a component of the fixed member, may include an insertion hole formed therein such that the sleeve 120 supporting the shaft 110, which is a shaft system of the spindle motor 10 according to the embodiment of the present invention, is coupled thereto. The base 190 may include the core 180 coupled thereto, wherein the core 180 includes the coil 170 wound therearound and the coil 170 generates electromagnetic force having a predetermined magnitude at the time of application of power.

The base 190 may be coupled to the sleeve 120 and the core 180 by any one of an adhesive bonding method, a welding method, and a press-fitting method.

Meanwhile, the base 190 may be manufactured by performing a single process through press processing or additional processes on a cold rolled steel sheet (SPCC, SPCE, or the like) or a hot rolled steel sheet, unlike being manufactured by a post-processing scheme in which aluminum (Al) is die-cast and burrs, or the like, generated due to the die-casting is then removed.

That is, the base 190 may be manufactured by disposing a plate-shaped metal material, which is a base material, that is, a lightweight alloy steel sheet such as a cold rolled steel sheet (SPCC, SPCE, or the like), a hot rolled steel sheet, a stainless steel, a boron or magnesium alloy, or the like, or a non-ferrous metal plate in a press mold and pressing the plate-shaped metal material at a predetermined pressure.

Therefore, the base 190 manufactured by press processing may be magnetic due to characteristics of the plate-shaped metal material, which is the base material. Due to these characteristics, magnetic attraction force F3 acts between the base 190 and the magnet 160 provided on the hub 150.

Since the magnetic attraction force F3 between the magnet 160 and the base 190 as described above has an effect on magnetic attraction force due to a difference in position between a magnetic center C1 of the magnet 160 and a center C2 of the core 180 to be described below, the magnetic attraction force F3 has an effect on rotational characteristics of the rotating member including the shaft 110 and the hub 150.

Therefore, in order to block the magnetic attraction force F3 between the magnet 160 and the base 190 as described above, the magnet 160 may include a shielding part 100, which will be described in detail below.

Meanwhile, the center C2 of the core 180 coupled to the base 190 may be disposed at a position higher than that of the center C1 of the magnet 160 coupled to the hub 150 in the axial direction. Therefore, force F2 directed upwardly in the axial direction is generated in the hub 150 due to magnetic attraction force allowing the center C1 of the magnet 160 to coincide with the center C2 of the core 180.

The force F2 may allow the thrust plate 130 coupled to the shaft 110 and the sleeve 120 to be maintained in a state in which they contact each other when the spindle motor 10 according to the embodiment of the present invention is stopped.

Meanwhile, the thrust plate 130 may be coupled to a lower portion of the shaft 110 to thereby allow the shaft 110 and the hub 150 to rotate while descending.

The thrust plate 130 may be coupled to the shaft 110 by an adhesive bonding method, a welding method, a press-fitting method, or the like, and may also be formed integrally with the shaft 110, rather than being a separate member from the shaft 110.

Here, the thrust plate 130 may be maintained in a state in which it contacts the lower surface of the sleeve 120 when the spindle motor is stopped, and force allowing the thrust plate to be maintained in a state in which it contacts the lower surface of the sleeve 120 may be generated by a difference in height between the center C2 of the core 180 and the center C1 of the magnet 160 coupled to the hub 150 as described above.

That is, since the center C1 of the magnet 160 coupled to the hub 150 is disposed at a position lower than that of the center C2 of the core 180, the force F2 directed upwardly in the axial direction may be usually generated in the hub 150 due to the magnetic attraction force between the magnet 160 and the core 180.

Therefore, when the spindle motor 10 according to the embodiment of the present invention is stopped, the thrust plate 130 and the sleeve 120 may be maintained in a state in which they contact each other, and the force F2 due to the magnetic attraction force directed upwardly in the axial direction needs to be formed greater than the entire weight of the rotating member including the shaft 110 and the hub 150.

Here, the weight of the rotating member may include the entire weight of all rotating components such as the shaft 110, the thrust plate 130, the hub 150, a disk (not shown), a clamp (not shown) for the fixation of the disk (not shown), and the like, and a magnitude of magnetic attraction force between the core 180 and the magnet 160 may be in proportion to a distance between the center C2 of the core 180 and the center C1 of the magnet 160.

Therefore, when the spindle motor 10 according to the embodiment of the present invention is stopped, the upper surface of the thrust plate 130 and the lower surface of the sleeve 120 are maintained in a state in which they contact each other, such that the clearance between the upper surface of the sleeve 120 and the lower surface of the hub 150 at the time of stoppage of the spindle motor 10 is larger than the clearance therebetween at the time of rotation of the spindle motor 10.

In addition, the magnetic attraction force due to the difference in height between the center C1 of the magnet 160 and the center C2 of the core 180 may continuously act even in the case in which the spindle motor 10 according to the embodiment of the present invention rotates, and the force F2 directed upwardly in the axial direction in the hub 150 due to the magnetic attraction force may prevent the rotating member from excessively descending.

In addition, when power is applied to the coil 170, the thrust plate 130 may pump the oil O filled between the thrust plate 130 and the sleeve 120 in the inner diameter direction by the thrust dynamic pressure part 132 to thereby allow the rotating member including the thrust plate 130 to rotate while descending.

Here, the thrust dynamic pressure part 132 may be formed in the lower surface of the sleeve 120 as shown in FIG. 3. However, the thrust dynamic pressure part 132 is not limited to being formed in the lower surface of the sleeve 120, but may be formed in the upper surface of the thrust plate 130.

That is, when power is applied to the coil 170 in order to rotate the rotating member of the spindle motor 10 according to the embodiment of the present invention, the rotating member including the thrust plate 130 may rotate.

At this time, the oil O filled between the thrust plate 130 and the sleeve 120 may be pumped in the inner diameter direction by the thrust dynamic pressure part 132 formed in at least one of the upper surface of the thrust plate 130 and the lower surface of the sleeve 120 to thereby generate the thrust dynamic pressure.

As a result, the thrust dynamic pressure part 132 may generate the thrust dynamic pressure via the oil O at the time of the rotation of the shaft 110, and the thrust dynamic pressure may generate the force F1 directed downwardly in the axial direction on the upper surface of the thrust plate 130.

Therefore, when power is applied to the coil 170, the rotating member including the shaft 110, the thrust plate 130, and the hub 150 may rotate while descending by the force F1 acting on the thrust plate 130 and directed downwardly in the axial direction.

In addition, at the time of the rotation of the spindle motor 10 according to the embodiment of the present invention, the force F2 generated due to the difference in position between the magnetic center C1 of the magnet 160 and the center C2 of the core 180 and directed upwardly in the axial direction may serve to prevent the rotating member from rotating while excessively descending.

The shielding part 100 may be provide on a lower surface of the annular ring-shaped magnet 160 by a coupling method such as a bonding method, or the like, and be magnetic.

Here, a lower surface of the shielding part 100 and the lower surface of the hub 150 may be disposed on the same plane, but are not necessarily limited thereto.

In addition, the shielding part 100 may block magnetic flux introduced from the magnet 160 provided on the hub 150 into the base 190 to thereby increase magnetic flux density between the magnet 160 and the core 180.

In other words, since the base 190 provided in the spindle motor 10 according to the embodiment of the present invention is formed by press-processing the plate shaped-metal material, the base 190 may be magnetic.

Therefore, a flow of magnetic flux from the magnet 160 provided on the hub 150 toward the base 190 may be inevitably generated. This flow of the magnetic flux generates the magnetic attraction force F3 between the magnet 160 and the base 190.

That is, the magnet 160 has limited magnetic flux; however, when leaked magnetic flux flowing into the base 190 increases due to the base 190 being magnetic, magnetic flux directed in the inner diameter direction, that is, magnetic flux flowing between the magnet 160 and the core 180 may decrease.

Therefore, the magnetic flux flowing between the magnet 160 and the core 180 decrease due to the base 190, such that rotational characteristics are deteriorated.

However, the spindle motor 10 according to the embodiment of the present invention includes the shielding part 100 provided on the magnet 160, whereby the leaked magnetic flux, which is the magnetic flux directed from the magnet 160 toward the base 190, may be blocked.

In other words, the shielding part 100 may guide the flow of the magnetic flux introduced from the magnet 160 between the magnet 160 and the core 180 to thereby increase magnetic flux density between the magnet 160 and the core 180 simultaneously with blocking the leaked magnetic flux introduced into the base 190 in advance.

In addition, the shielding part 100 may block the magnetic attraction force between the magnet 160 and the base 190 to thereby significantly reduce an effect of the difference in position between the magnetic center C1 of the magnet 160 and the center C2 of the core 180 on the magnetic attraction force.

In other words, in the spindle motor 10 according to the embodiment of the present invention, a new shaft system in which the shaft 110 and the hub 150 rotate while descending is used. To this end, the new shaft system is implemented by the difference in position between the magnetic center C1 of the magnet 160 and the center C2 of the core 180.

Therefore, in order to allow the shaft 110 and the hub 150 to rotate while being maintained at a stable rotation height, the spindle motor 10 needs to be designed such that a magnitude of the magnetic attraction force between the magnet 160 and the core 180 is controlled, and a preset magnitude of the magnetic attraction force between the magnet 160 and the core 180 needs not to be affected by external factors.

However, unavoidably, the base 190 manufactured by the press processing may be basically magnetic due to characteristics of the plate-shaped metal material, which is the base material. Therefore, the magnetic attraction force F3 acts between the base 190 and the magnet 160 provided on the hub 150.

The magnetic attraction force F3 acting between the magnet 160 and the base 190 may have an effect on the preset magnetic attraction force between the magnet 160 and the core 180 to thereby hinder implementation of stable rotational characteristics.

However, according to the embodiment of the present invention, the magnet 160 includes the shielding part 100 to block the magnetic attraction force F3 between the magnet 160 and the base 190 in advance, such that the magnetic attraction force between the magnet 160 and the core 180 is maintained, whereby the stable rotational characteristics may be implemented.

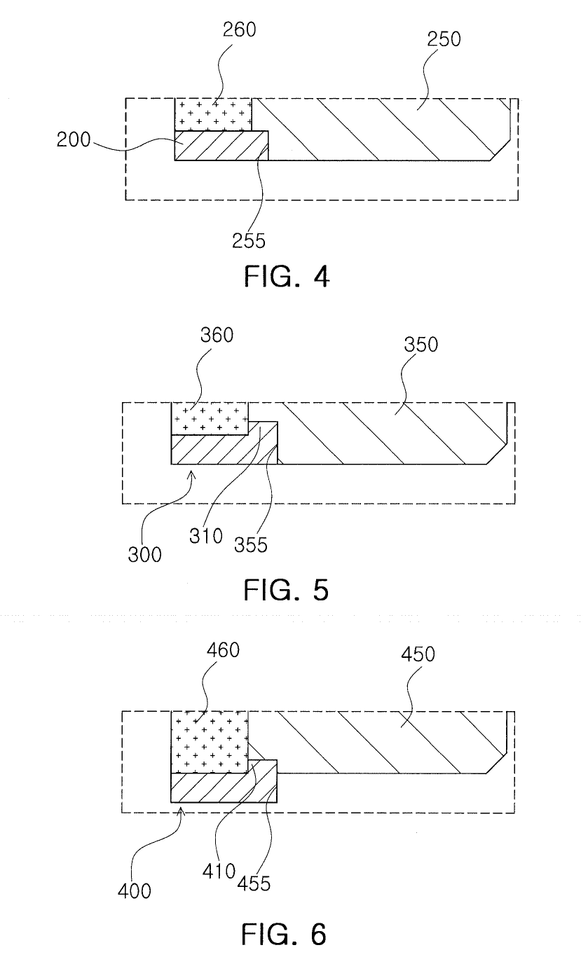

FIG. 4 is a schematic enlarged cross-sectional view showing a seventh modified example of part A of FIG. 1.

Referring to FIG. 4, a shielding part 200 may be provided on a lower surface of a magnet 260 and extended outwardly of the magnet 260, to thereby be coupled to a hub 250.

Here, the hub 250 may include a receiving part 255 for receiving an outer edge of the shielding part 200 therein, wherein the receiving part 255 may be formed by depressing a portion thereof corresponding to the outer edge of the shielding part 200 in the outer diameter direction.

As a result, the receiving part 255 may be implemented by forming one surface of the hub 250 corresponding to an outer peripheral surface of the magnet 260 in a stepped manner and may be continuously formed in the circumferential direction.

FIG. 5 is a schematic enlarged cross-sectional view showing a second modified example of part A of FIG. 1; and FIG. 6 is a schematic enlarged cross-sectional view showing a third modified example of part A of FIG. 1.

Referring to FIG. 5, a shielding part 300 may be provided on a lower surface of a magnet 360 and include an extension part 310 formed by bending an outer side thereof upwardly in the axial direction.

The extension part 310 may be received in a receiving part 355 provided in a hub 350 to thereby be coupled to the hub 350, and a lower surface of the shielding part 300 and a lower surface of the hub 350 may be disposed on the same plane.

Referring to FIG. 6, a shielding part 400 may include an extension part 410 formed by bending an outer side thereof upwardly in the axial direction, similar to the shielding part 300 shown in FIG. 5.

Here, a lower surface of the shielding part 400 may be disposed at a position lower than that of a lower surface of a hub 450 in the axial direction, and a lower surface of a magnet 460 and the lower surface of the hub 450 may be disposed on the same plane.

In addition, the extension parts 310 and 410 of the shielding parts 300 and 400 described with reference to FIGS. 5 and 6 may be extended up to outer peripheral surfaces of the hubs 350 and 450 to thereby enclose the hub 350 and 450, respectively.

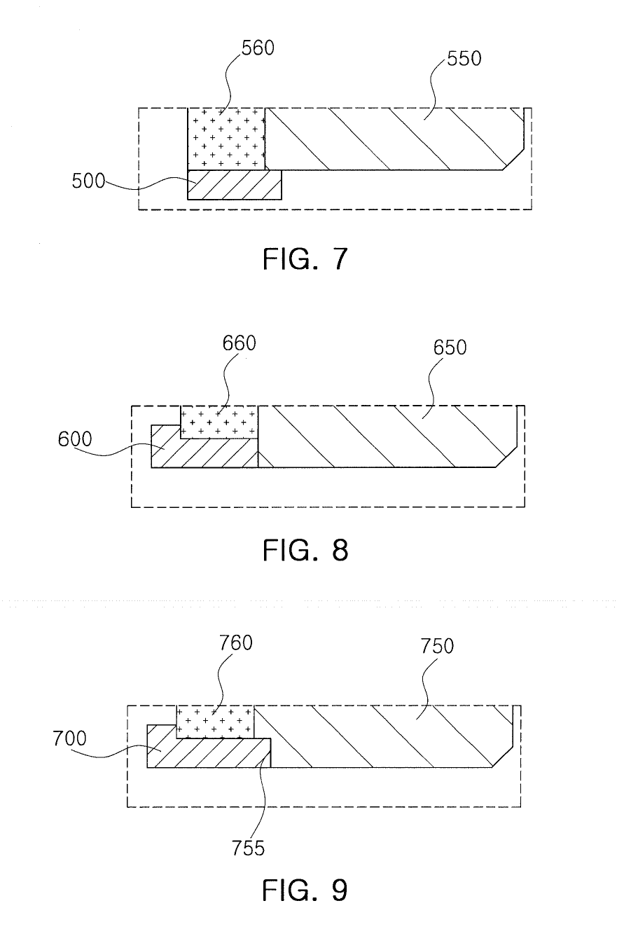

FIG. 7 is a schematic enlarged cross-sectional view showing a fourth modified example of part A of FIG. 1.

Referring to FIG. 7, a shielding part 500 may be provided on a lower surface of a hub 550 and also provided on a lower surface of a magnet 560.

That is, the lower surface of the magnet 560 and the lower surface of the hub 550 may be disposed on the same plane, and the shielding part 500 may be disposed at a position lower than that of the lower surface of the hub 550 in the axial direction.

FIG. 8 is a schematic enlarged cross-sectional view showing a fifth modified example of part A of FIG. 1; and FIG. 9 is a schematic enlarged cross-sectional view showing a sixth modified example of part A of FIG. 1.

Referring to FIGS. 8 and 9, shielding parts 600 and 700 may be extended from lower surfaces of magnets 660 and 760 to inner peripheral surfaces of the magnets 660 and 760 to thereby be coupled to the inner peripheral surfaces of the magnets 660 and 760, respectively.

In addition, as shown in FIG. 9, a hub 750 may include a receiving part 755 formed therein to thereby receive an outer side of the shielding part 700.

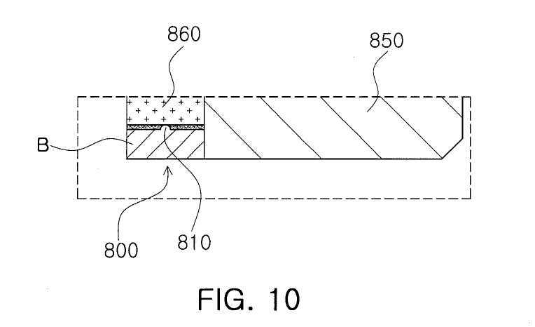

FIG. 10 is a schematic enlarged cross-sectional view showing a seventh modified example of part A of FIG. 1.

Referring to FIG. 10, a shielding part 800 may have at least one protrusion part 810 formed on a surface thereof corresponding to a lower surface of a magnet 860, wherein the protrusion part 810 may contact the lower surface of the magnet 860.

Here, a clearance between the lower surface of the magnet 860 and the shielding part 800 may be filled with an adhesive B to thereby more firmly couple the magnet 860 and the shielding part 800 to each other.

As set forth above, with the spindle motor according to the embodiment of the present invention, rotational characteristics can be improved by significantly reducing the leaked magnetic flux of the magnet electromagnetically interacting with the coil to generate rotational driving force.

In addition, a new shaft system structure may be provided to implement a stable rotation height of the rotating member.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a hub operating together with a shaft and including a magnet;
a base coupled to a sleeve supporting the shaft and including a core having a coil wound therearound, the coil generating rotational driving force; and
a shielding part provided on the magnet and blocking magnetic flux introduced from the magnet into the base to thereby increase magnetic flux density between the magnet and the core,
wherein the shaft and the hub rotate while descending via oil when power is applied to the coil.

2. The spindle motor of claim 1, wherein the shielding part is provided on a lower surface of the magnet.

3. The spindle motor of claim 1, wherein the shielding part is magnetic.

4. The spindle motor of claim 1, wherein the shielding part is extended outwardly of the magnet to thereby be coupled to the hub.

5. The spindle motor of claim 1, wherein the hub includes a receiving part receiving an outer side of the shielding part therein, and
the shielding part is received in the receiving part to thereby be coupled to the hub.

6. The spindle motor of claim 5, wherein the shielding part includes an extension part formed by bending an outer side thereof upwardly in an axial direction, and
the extension part is received in the receiving part to thereby be coupled to the hub.

7. The spindle motor of claim 1, wherein the shielding part is extended to an outer peripheral surface of the hub to thereby enclose the outer peripheral surface of the hub.

8. The spindle motor of claim 1, wherein the shielding part is extended from a lower surface of the magnet to an inner peripheral surface of the magnet to thereby be coupled to the inner peripheral surface of the magnet.

9. The spindle motor of claim 1, wherein the shielding part has at least one protrusion part formed on a surface thereof corresponding to a lower surface of the magnet, the protrusion part contacting the magnet to thereby be coupled to the magnet.

10. The spindle motor of claim 1, wherein the base is magnetic.

11. The spindle motor of claim 1, further comprising a thrust plate coupled to a lower portion of the shaft,
wherein force allowing the shaft and the hub to descend is generated by thrust dynamic pressure via the oil by a thrust dynamic pressure part formed in at least one of an upper surface of the thrust plate and the sleeve facing the upper surface of the thrust plate.

12. The spindle motor of claim 11, wherein the thrust plate and the sleeve are maintained in a state in which they contact each other when the spindle motor is stopped.

13. The spindle motor of claim 11, wherein the shaft and the thrust plate are formed integrally with each other.

14. The spindle motor of claim 1, wherein a magnetic center of the magnet is disposed at a position lower than that of a center of the core in an axial direction.

15. The spindle motor of claim 1, wherein the oil is sealed by an interface of the oil formed between an upper surface of the sleeve and a lower surface of the hub facing the upper surface of the sleeve.
